(19) United States
(12) Patent Application Publication
(10) Pub. No.: US 2011/0132230 A1
(43) Pub. Date: Jun. 9, 2011

(54) GEOPOLYMER PRECURSOR DRY MIXTURE, PACKAGE, PROCESSES AND METHODS

(76) Inventors: Chan Han, Midland, MI (US); Aleksander J. Pyzik, Midland, MI (US)

(21) Appl. No.: 12/952,239

(22) Filed: Nov. 23, 2010

Related U.S. Application Data
(60) Provisional application No. 61/267,598, filed on Dec. 8, 2009.

(51) Int. Cl. C04B 28/26

(52) U.S. Cl. 106/600

(57) ABSTRACT

The present invention generally relates to a geopolymer precursor dry mixture, geopolymer precursor package, a process of preparing a geopolymer composition, and a method of providing a geopolymer composition to a geopolymer composition preparation site.

### CROSS-REFERENCE TO RELATED APPLICATIONS

This application claims benefit from U.S. Provisional Patent Application No. 61/267,598, filed Dec. 8, 2009, the entire contents of which are hereby incorporated herein by reference.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Field of the Invention

The present invention generally relates to a geopolymer precursor dry mixture, geopolymer precursor package, a process of preparing a geopolymer composition, and a method of providing a geopolymer composition to a geopolymer composition preparation site.

2. Description of Related Art

Geopolymer compositions have been used in construction (e.g., to make bricks, and coat or reinforce structural members) for centuries. Basic geopolymer compositions contain elements that include hydrogen, aluminum, silicon, oxygen, and a metal of Group 1 of the Periodic Table of the Elements.

A geopolymer composition typically is prepared as follows. Prepare an aqueous metal silicates solution by dissolving a solid silica in an aqueous alkali base (e.g., aqueous sodium hydroxide or aqueous sodium carbonate); when the solid silica is sand particles (which are relatively coarse and crystalline), typically this dissolution requires elevated temperature and pressure or more than 24 hours at room temperature. When the solid silica is an amorphous silica powder having high surface area and submicrometer particle size (e.g., fumed silica), the dissolution can be accomplished within 1 hour to 2 hours to prepare the aqueous metal silicate solution. Combine the aqueous metal silicate solution with a powder source of aluminosilicate (e.g., a calcined kaolin clay) to give the geopolymer composition. High surface area amorphous silica powder, however, is sold at a much higher cost relative to cost of sand and so the use of amorphous silica powder to prepare industrial-scale quantities of geopolymer compositions is uneconomic.

Another problem has been that once prepared, geopolymer compositions immediately begin curing (i.e., hardening). This presents substantial problems to users of geopolymer compositions such as the construction industry. The construction industry must prepare geopolymer compositions at a construction site or prepare it off-site and quickly transport it to the construction site before the geopolymer compositions unacceptably harden and become unusable. Accordingly, geopolymer compositions prepared at a separate manufacturing site typically have been quickly frozen, transported to the construction site, unfrozen, and then used at the construction site. Freezing such mass is expensive and the steps have to be performed quickly. Further, varying proportion of ingredients of the geopolymer compositions requires preparing and transporting separate batches thereof. Alternatively, aluminosilicates powder and the aforementioned metal silicate solution have been transported in separate containers to the construction site. There the aluminosilicates powder and metal silicate solution are mixed together so as to prepare a geopolymer composition on-site. Varying proportion of ingredients of the metal silicate solutions, and thus varying proportion of ingredients of their associated geopolymer compositions, requires preparing and transporting separate batches of the metal silicate solutions. Also, either alternative undesirably requires costly transportation of water (in frozen or liquid form, respectively) from the manufacturing site to the construction site.

Recently, WO 2007/109862 A1 mentions, among other things, a thermally-activated, alkaline multi-phase aluminosilicates material. The material has been thermally activated by calcining it at a temperature of from 150 degrees Celsius (° C.) to 1500° C. or by subjecting it to an alternative thermal activating technique such as mechanochemical (ultrafine grinding) activation, microwave heating, or infrared or electromagnetic energy. In addition to the undesirable requirement for thermal activation, varying proportion of ingredients of the alkaline multi-phase aluminosilicates material undesirably requires preparing separate batches of the alkaline multi-phase aluminosilicates material.

There has long been a need in the art for a preparation of geopolymer compositions directly from dry ingredients and water. There also has long been a need in the art for a cost effective and flexible means for providing geopolymer compositions to geopolymer preparation and use sites. Preferably the cost effective means avoids vehicular transport of water and thermal activation of ingredients. Preferably the flexible means allows preparation of geopolymer compositions of varying proportions of ingredients at the sites.

### BRIEF SUMMARY OF THE INVENTION

In a first embodiment, the present invention provides a geopolymer precursor dry mixture comprising a water soluble metal silicate powder and an aluminosilicate powder.

In a second embodiment, the present invention provides a process for preparing a geopolymer composition, the process comprising mixing water and the geopolymer precursor dry mixture of the first embodiment together in such a way so as to prepare a geopolymer composition.

In a third embodiment, the present invention provides a method of preparing a geopolymer composition at a geopolymer composition preparation site in need thereof, the method comprising providing the geopolymer precursor dry mixture of the first embodiment to a geopolymer composition preparation site in need of a geopolymer composition, the geopolymer composition preparation site comprising a source of water; and mixing water from the source of water, and the geopolymer precursor dry mixture of the first embodiment together in such a way so as to prepare the geopolymer composition at the geopolymer composition preparation site.

In a fourth embodiment, the present invention provides a geopolymer precursor package comprising a packaged dry mixture comprising a water soluble metal silicate powder and an aluminosilicate powder and instructions for mixing the packaged dry mixture with water, and optionally a first supplemental ingredient, in such a way so as to prepare a geopolymer composition, the first supplemental ingredient comprising a particulate solid alkali base or an amorphous silica-containing powder.

In a fifth embodiment, the present invention provides a process for preparing a geopolymer composition, the process comprising mixing the packaged dry mixture comprising the geopolymer precursor package of the fourth embodiment, water, and optionally a first supplemental ingredient, together in such a way so as to prepare a geopolymer composition, the first supplemental ingredient comprising a particulate solid alkali base or an amorphous silica-containing powder.

The invention advantageously provides, among other things, a means for directly (i.e., without employing an intermediate solution such as a metal silicate solution) and rapidly (e.g., less than 1 hour) preparing a geopolymer composition by contacting solid ingredients (the geopolymer precursor dry mixture or packaged dry mixture) and water together. The invention also provides a stable, storable, and transportable source of ingredients other than water for geopolymer compositions, the stable, storable, and transportable source comprising the geopolymer precursor dry mixture or packaged dry mixture. The stability, storability, and transportability characteristics of the geopolymer precursor dry mixture and packaged dry mixture lend the geopolymer precursor and packaged dry mixtures to being a flexible means of freshly preparing geopolymer compositions of same or varying proportions of ingredients and of doing such preparations at any geopolymer composition preparation site, no matter how remote the geopolymer composition preparation site is from sites where the geopolymer precursor and packaged dry mixtures are manufactured. Another benefit is that the invention desirably avoids transportation of water-based geopolymer ingredients to the geopolymer composition preparation site. Once at the geopolymer composition preparation sites, the geopolymer precursor dry mixture or packaged dry mixture can be contacted with water (e.g., water from a water utility or a natural body of water such as a river or lake) and any optional supplemental ingredients sourced therefrom in varying proportions as desired so as to make geopolymer compositions of same or varying proportions of ingredients thereof. All of the aforementioned advantages and means can be, and preferably are, achieved by the invention without thermally activating the geopolymer precursor dry mixture or packaged dry mixture.

The geopolymer compositions prepared by the invention are characterizable as being conventionally curable and dryable, thereby preparing cured and dried geopolymers. The cured and dried geopolymers are characterizable as independently having one or more properties (e.g., compressive strength, adhesive strength (e.g., in coating and adhesive applications), and satisfactory mechanical properties) at least comparable to corresponding properties of cured and dried geopolymers that have been prepared from conventionally made geopolymer compositions. Thus, the geopolymer compositions prepared by the invention are useful in preparing articles comprising geopolymer and in geopolymer applications, which are described later.

Additional embodiments are described in the remainder of the specification, including the claims.

### DETAILED DESCRIPTION OF THE INVENTION

The present invention relates to a geopolymer precursor dry mixture, geopolymer precursor package a process of preparing a geopolymer composition, and a method of providing a geopolymer composition to a geopolymer composition preparation site as summarized above. In still another embodiment the present invention provides a geopolymer composition prepared by the process of the second embodiment.

For purposes of United States patent practice and other patent practices allowing incorporation of subject matter by reference, the entire contents—unless otherwise indicated—of each U.S. patent, U.S. patent application, U.S. patent application publication, PCT international patent application and WO publication equivalent thereof, referenced in the instant Detailed Description of the Invention are hereby incorporated by reference. In an event where there is a conflict between what is written in the present specification and what is written in a patent, patent application, or patent application publication, or a portion thereof that is incorporated by reference, what is written in the present specification controls.

In the present application, any lower limit of a range of numbers, or any preferred lower limit of the range, may be combined with any upper limit of the range, or any preferred upper limit of the range, to define a preferred aspect or embodiment of the range. Each range of numbers includes all numbers, both rational and irrational numbers, subsumed within that range (e.g., the range from about 1 to about 5 includes, for example, 1, 1.5, 2, 2.75, 3, 3.80, 4, and 5).

In an event where there is a conflict between a unit value that is recited without parentheses, e.g., 2 inches, and a corresponding unit value that is parenthetically recited, e.g., (5 centimeters), the unit value recited without parentheses controls.

As used herein, “a,” “an,” “the,” “at least one,” and “one or more” are used interchangeably. In any aspect or embodiment of the instant invention described herein, the term “about” in a phrase referring to a numerical value may be deleted from the phrase to give another aspect or embodiment of the instant invention. In the former aspects or embodiments employing the term “about,” preferably it means from 90 percent to 100 percent of the numerical value, from 100 percent to 110 percent of the numerical value, or from 90 percent to 110 percent of the numerical value. In any aspect or embodiment of the instant invention described herein, the open-ended terms “comprising,” “comprises,” and the like (which are synonymous with “including,” “having,” and “characterized by”) may be replaced by the respective partially closed phrases “consisting essentially of,” consists essentially of,” and the like or the respective closed phrases “consisting of,” “consists of,” and the like to give another aspect or embodiment of the instant invention. In the present application, when referring to a preceding list of elements (e.g., ingredients), the phrases “mixture thereof,” “combination thereof,” and the like mean any two or more, including all, of the listed elements. The term “or” used in a listing of members, unless stated otherwise, refers to the listed members individually as well as in any combination, and supports additional embodiments reciting any one of the individual members (e.g., in an embodiment reciting the phrase “10 percent or more,” the “or” supports another embodiment reciting “10 percent” and still another embodiment reciting “more than 10 percent.”). The term “plurality” means two or more, each plurality being independently selected unless indicated otherwise. The terms “first,” “second,” et cetera serve as a convenient means of distinguishing between two or more elements or limitations (e.g., a first chair and a second chair) and do not imply quantity or order unless specifically so indicated. The term “optionally” means “with or without.” For example, “optionally a supplemental ingredient” means with or without a supplemental ingredient. As used herein, “weight percent” and “wt %” are synonymous and are calculated for a component of a mixture based on total weight of the mixture unless indicated otherwise.

Unless otherwise noted, the phrase “Periodic Table of the Elements” refers to the official periodic table, version dated Jun. 22, 2007, published by the International Union of Pure and Applied Chemistry (IUPAC). Also any references to a Group or Groups shall be to the Group or Groups reflected in this Periodic Table of the Elements.

The term “geopolymer composition” means a three-dimensional inorganic aluminosilicate mineral polymer that comprises a hydrated polysialate. Preferably, the hydrated polysialate is of empirical formula (G):

(M)_{y}[—(—SiO₂)_{Z}—AlO₂)]_{X}.wH₂O (G),

wherein each M independently is a cation of Group 1 of the Periodic Table of the Elements; x is an integer of 2 or higher and represents a number of polysialate repeat units; y is a rational or irrational number selected so that a ratio of y to x is greater than zero (y/x>0), and preferably from greater than zero to less than or equal to 2 (0<y/x≦2); z is a rational or irrational number of from 1 to 35; and w is a rational or irrational number such that ratio of w to x (w/x) represents a ratio of moles of water per polysialate repeat unit. The z represents a molar ratio equal to moles of silicon atoms to moles of aluminum atoms (Si/Al) in the polysialate. The distribution of the SiO₂ functional groups in the invention geopolymer composition may be characterizable as being random. Thus, z can be a rational or irrational number.

In the hydrated polysialate of empirical formula (G), the w is preferably chosen to give a “geopolymer viscosity effective amount” of water, which means a quantity of water sufficient to a establish a desired resistance to flow for the geopolymer composition such that one or more of the aforementioned uses of the geopolymer compositions can be achieved. More preferably, w is a rational or irrational number of from about 5 to about 30. To give a desired geopolymer viscosity effective amount of water in the geopolymer composition, the w can be adjusted higher or lower by adding water to or removing (such as by drying) some water from the geopolymer composition. In some embodiments adjusting the effective amount of water indicated by variable, w, modulates water-affected properties of cured and dried geopolymer, examples of the water-affected properties being compressive strength and porosity. A skilled artisan can readily choose w so as to provide properties of cured and dried geopolymer for a particular intended use.

In the hydrated polysialate of empirical formula (G), preferably each M independently is a cation of one or more metals of Group 1 of the Periodic Table of the Elements. Most common cations comprise potassium cation (K⁺), sodium cation (Na⁺), lithium cation (Li⁺), or a combination of two or more thereof. In some embodiments, the cations may further comprise cations of one or more metals of Group 2 of the Periodic Table of the Elements, more preferably magnesium cation (Mg⁺²), and still more preferably calcium cation (Ca⁺²). In such embodiments, preferably the calcium cation does not comprise, and is not derived from, a calcium oxide. Preferably, from 51 mol % to 99 mol % of M are Na⁺.

In some geopolymer applications where one or more specific enhanced performance properties or characteristics are desired for the geopolymer composition (e.g., fast curing; enhanced adhesion; increased compressive strength; or both enhanced adhesion and increased compressive strength), in the hydrated polysialate of empirical formula (G), preferably z is a rational or irrational number of from 1 to 3, depending on the specific performance desired. In some embodiments, z is between 2 and 3 or, preferably, between 1 and 2. Preferably, z is 1.70 or greater and, more preferably, 1.9 or greater. Preferably, z is 3.0 or less. In some embodiments, z is 2.0 or less. In some embodiments, the hydrated polysialate of formula (G) comprises a poly(sialate) (z is 1 in empirical formula (G)), poly(sialate-siloxo) (z is 2 in empirical formula (G)), or poly(sialate-disiloxo) (z is 3 empirical formula (G)). Before any curing, the poly(sialate), poly(sialate-siloxo), and poly(sialate-disiloxo) each comprises a network of negatively charged tetrahedral silicon tetroxides (formally SiO₄) and tetrahedral aluminum tetroxides (formally AlO₄) linked by shared oxygen atoms thereof, cations such that the overall charge of the aluminosilicate mineral polymer is neutral, and water. The network of SiO₄ and AlO₄ tetrahedra defines structural cavities containing the cations M.

An example of hydrated polysialates for such enhanced adhesion, increased compressive strength, or both geopolymer applications includes, but is not limited to a poly(sialate-siloxo) of empirical formula (M-PSS): (M)_{y}-(Si—O—Al—O—Si—O—)_{X}.wH₂O (M-PSS), wherein molar ratio of Si to Al is 2:1 (z=2).

An example of hydrated polysialates for fast curing geopolymer applications includes, but is not limited to, a hydrated poly(sialate) of empirical formula (M-PS):

poly(sialate):(M)_{y}-(—Si—O—Al—O—)ₓ.wH₂O(M-PS),wherein molar ratio of Si to Al is 1:1 (z=1).

An example of hydrated polysialates for enhanced performance properties or characteristics other than enhanced adhesion, increased compressive strength, or fast curing includes, but is not limited to, a poly(sialate-disiloxo) of empirical formula (M-PSSS): (M)_{y}-(Si—O—Al—O—Si—O—Si—O—)ₓ.wH₂O (M-PSSS), wherein molar ratio of Si to Al is 3:1 (z=3).

In empirical formulas (M-PS), (M-PSS), and (M-PSSS), x, y, w, and M independently are as defined for empirical formula (G).

Hydrated polysialates having any molar ratio of Si to Al greater than 1 are contemplated, including molar ratios greater than 3.

After using the geopolymer composition in one or more of the geopolymer applications or for preparing one or more of the geopolymer articles (described later), the geopolymer composition preferably is cured and then dried. Curing the geopolymer composition to give a cured geopolymer can be done at any temperature suitable for curing the geopolymer composition. The term “curing temperature” means a degree of hotness or coldness at which the geopolymer composition is hardened by allowing bonding thereof. Preferably curing is done at a curing temperature greater than the freezing temperature of water (0° C.) and less than the boiling temperature of water (100° C.) at standard pressure and, more preferably, a curing temperature of from 20° C. to 40° C. Curing and drying temperatures and pressures may be the same or different.

Drying (i.e., removing water from) the cured geopolymer yields the cured and dried geopolymer. The drying preferably comprises evaporation, stripping, freeze-drying, or a combination thereof. Drying can be done at ambient pressure (e.g., 101 kPa), elevated pressure (e.g., greater than 110 kPa, but preferably less than 120 kPa), or reduced pressure (e.g., less than 95 kPa). Drying can be done at any temperature suitable for removing some water from the cured geopolymer so as to give the cured and dried geopolymer. Preferably, the drying temperature is 100 degrees Celsius (° C.) or less, more preferably less than 75° C., still more preferably less than 50° C., and even more preferably less than 40° C.; and independently preferably at least −10° C., more preferably at least −5, still more preferably at least 10° C., and even more preferably at least 15° C. In some embodiments, drying is done at ambient temperature (e.g., 10° C. to 40° C.) and comprises evaporation.

Geopolymer compositions of different proportions of ingredients (e.g., weight ratios of water soluble metal silicate powder to aluminosilicate powder, geopolymer precursor dry mixture to water, and packaged dry mixture to an optional supplemental ingredient) can be readily prepared by changing amounts of these ingredients in the preparation of their respective geopolymer precursor dry mixtures, packaged dry mixtures, or geopolymer compositions. Further, the geopolymer precursor dry mixture and packaged dry mixture, and the geopolymer composition, can be prepared on any scale from laboratory scale to multi-metric ton scale. Preparations on the multi-metric ton scale can be carried out by employing or readily adapting conventional equipment and techniques such as, for examples, equipment and techniques for preparing Portland cement or concrete products.

The invention geopolymer precursor dry mixture, which is used to prepare the geopolymer composition, comprises solid ingredients. The solid ingredients of the geopolymer precursor dry mixture comprise the water soluble metal silicate powder and aluminosilicate powder. Any water soluble metal silicate powder can be used in the present invention. As used herein the term “water soluble metal silicate powder” means an amorphous (i.e., substantially non-crystalline), finely divided substance comprising sodium or potassium, silicon and oxygen, the substantially non-crystalline substance being characterizable as having less than 50 weight percent (wt %) of an undissolved material, after mixing for 2 hours the substantially non-crystalline substance in water or aqueous sodium hydroxide (or other aqueous alkali base) used in preparing the geopolymer composition. Preferably, the water soluble metal silicate powder is characterizable by a dissolution rate as being more than 50 wt % dissolvable in an amount of water or aqueous sodium hydroxide used in preparing the geopolymer composition within 2 hours, more preferably within 1 hour, at ambient temperature and pressure. Typically the water soluble metal silicate powder having the dissolution rate is characterizable as being in a hydrous form in that it contains water of hydration, Preferably the water soluble metal silicate powder is characterized as comprising ingredients Na₂O and SiO₂, and more preferably a weight ratio of SiO₂ to Na₂O of from 1 to 3.5, and still more preferably from 1.1 to 3.3 (e.g., 1.1 to 3.22). Examples of the water soluble metal silicate powder are amorphous sodium, potassium, or lithium silicate powders. Preferred is water soluble sodium silicate powder.

Some of the water soluble metal silicate powders such as the water soluble sodium silicate powder can be obtained from commercial sources (e.g., PQ Corporation, Malvern, Pa., USA). Alternatively the water soluble metal silicate powder can be prepared by, for example, first preparing an aqueous metal silicate solution, then removing water therefrom or, preferably, combining sand, soda ash (sodium carbonate) at high temperature, all in such a way so as to give the water soluble metal silicate powder. Prepare the aqueous metal silicate solution by, for example, combining ingredients water, particulate solid alkali base, and a metal silicate material. Stir the resulting mixture for a period of time as described herein, thereby preparing the aqueous metal silicate solution. In some embodiments the amorphous metal silicate powder comprises amorphous potassium silicate powder, and more preferably amorphous sodium silicate powder.

Any aluminosilicate powder can be used in the present invention. The term “aluminosilicate” means a material comprising aluminum, silicon and oxygen. In some embodiments the aluminosilicate comprises a mineral, preferably the mineral being a clay substance primarily having a composition Al₂Si₂O₅(OH)₄ (found in a kaolin clay mineral, also known as a kaolinite) or Al₂SiO₅ (found in an andalusite, kyanite, or silimanite clay mineral), or a calcination product thereof. In some embodiments the aluminosilicate comprises a non-mineral material such as, for example, fly ash or slag. The invention also contemplates aluminosilicates comprising a mixture of mineral and non-mineral materials. The aluminosilicate can further comprise other elements such as iron, an alkali metal, or combination thereof. Examples of the aluminosilicate powder are inorganic clays (e.g., kaolin powder), calcined inorganic clays (e.g., calcined kaolin powder), slag, and fly ash. In some embodiments the aluminosilicate powder comprises a calcined inorganic clay, more preferably calcined kaolin powder. Preferably the aluminosilicate powder is characterizable as being substantially soluble in an aqueous solution of the water soluble metal silicate at ambient temperature and pressure, the amounts of water and water soluble metal silicate of the aqueous solution being as described herein for preparing the geopolymer composition. Preferably the calcined kaolin powder is characterizable as being substantially dissolvable (i.e., 90 wt % or greater, and more preferably 95 wt % or greater dissolvable) in the aforementioned aqueous metal silicate solution.

The geopolymer compositions are prepared as described herein from the geopolymer precursor dry mixture, water, and any optional supplemental ingredients described herein. In some embodiments the geopolymer precursor dry mixture, and the geopolymer composition prepared therefrom, further comprises, and the instructions for mixing optionally names, one or more supplemental ingredients. The supplemental ingredients can be a solid or liquid. Solid supplemental ingredients are preferred. Liquid supplemental ingredient, if any, preferably is added to prepare the geopolymer composition at the geopolymer preparation site simultaneously with addition of water or after water is added.

Preferably the geopolymer precursor dry mixture of the first embodiment further comprises a first supplemental ingredient, the first supplemental ingredient comprising a particulate solid alkali base or an amorphous silica-containing powder. The term “alkali base” means an alkali metal carbonate or, preferably, an alkali metal hydroxide, or a mixture thereof. As used herein, the term “alkali metal” means a cation of a Group 1 metal, preferably a cation of lithium, potassium, or sodium; more preferably a cation of sodium or potassium; and still more preferably a cation of sodium. A preferred particulate solid alkali base is particulate solid sodium or potassium carbonate or sodium or potassium hydroxide, or more preferably particulate solid sodium hydroxide or sodium carbonate. In some embodiments the particulate solid form of the alkali base is characterizable as being a powder, granules, pellets, or mixture thereof. Preferably the particulate solid alkali base comprises particulate solid sodium hydroxide or particulate solid sodium carbonate, more preferably sodium hydroxide powder or pellets or sodium carbonate powder or granules.

The term “amorphous silica-containing powder” means a finely divided, substantially non-crystalline solid form of an SiO₂-containing material having a silica to alumina weight ratio of from 0.1 to 9. Preferably at least some of the amorphous silica-containing powder is dissolvable in the aqueous metal silicate solution. Examples of the amorphous silica-containing powder are fumed silica, fly ash, and slag. The term “fly ash” means a finely divided residue produced during combustion of coal. The term “slag” means a material (e.g., a calcium silicate) produced during smelting or refining of a metal by reaction of a flux (e.g., calcium oxide flux) with impurities (e.g., silicon dioxide impurities). Preferably, the amorphous silica-containing powder comprises, more preferably consists essentially of, a fumed silica. Preferably the fumed silica is characterizable as having a high surface area (e.g., greater than 100 square meters per gram) and average particle size of less than 1000 nanometers (i.e., less than 1 micron).

In other embodiments the first supplemental ingredient is a supplemental ingredient other than the particulate solid alkali base or amorphous silica-containing powder. Other examples of supplemental ingredients are organic polymer latexes (introduced in solid (dry particle) form or in water-borne latex form); organic polymer particles; cellulose materials such as methyl cellulose and ethyl cellulose; non-aqueous liquids (e.g., silanes); inorganic particles; organic and inorganic fibers; natural and synthetic fibers such as wollastonite fibers and glass fibers; organic and inorganic pigments; natural and synthetic granules and powders such as ground glass powder, sand, fly ash, and slag; rheology modifiers; curing accelerators; curing inhibitors; Portland cement; stone aggregates; surfactants; and stabilizers (e.g., latex stabilizers). For example, organic polymer latexes can be added to improve adhesion of the geopolymer composition or cured and dried geopolymer residual thereof to a surface of an organic polymer (e.g., polystyrene) article. If desired, methyl or ethyl cellulose materials can be added to the geopolymer composition to increase water retention thereby. Silanes can be added to decrease water absorption by the geopolymer composition or cured and dried geopolymer residual thereof. Liquid supplemental ingredients are, preferably, added to the geopolymer composition (already containing water), and not to the dry mixture of precursor geopolymer. A more preferred supplemental ingredient is fumed silica.

While the geopolymer precursor dry mixture in some embodiments comprises 1 or more liquid supplemental ingredients (preferably being a total of 10 wt % or less of the geopolymer precursor dry mixture), preferably the geopolymer precursor dry mixture consists essentially of solid ingredients. more preferably the geopolymer precursor dry mixture consists of only solid ingredients, including, but not limited to, hydrous forms of solid ingredients (i.e., molecular forms having water of hydration). If desired, any number of different solid supplemental ingredients, reactive or inert (as described later) in the geopolymer composition ultimately prepared therewith, can be added to the geopolymer precursor dry mixture. Preferably the supplemental ingredients are solid supplemental ingredients and the geopolymer precursor dry mixture further comprises at least one solid supplemental ingredient. Preferably the geopolymer precursor dry mixture is characterizable as having at least 1 solid supplemental ingredient (i.e., a total of 3 or more solid ingredients), and more preferably at least 2 solid supplemental ingredients (i.e., a total of 4 or more solid ingredients). More preferably at least one of the solid supplemental ingredients is the first supplemental ingredient, the first supplemental ingredient comprising a particulate solid alkali base or an amorphous silica-containing powder. Where there are two or more first supplemental ingredients, each one independently can be the same as or different from another one. For convenience and cost reasons, preferably the geopolymer precursor dry mixture is characterizable as having 10 or fewer solid supplemental ingredients (i.e., a total of 12 or fewer solid ingredients). Accordingly in some embodiments the geopolymer precursor dry mixture consists essentially of a total of 3 to 7 solid ingredients. In some embodiments the geopolymer precursor dry mixture consists essentially of a total of 3 solid ingredients. In some embodiments the geopolymer precursor dry mixture consists essentially of a total of 4 solid ingredients. In some embodiments the geopolymer precursor dry mixture consists essentially of a total of 5 solid ingredients. In some embodiments the geopolymer precursor dry mixture consists essentially of a total of 6 solid ingredients. In some embodiments the geopolymer precursor dry mixture consists essentially of a total of 7 solid ingredients. In some embodiments the geopolymer precursor dry mixture consists essentially of a total of 8 to 12 solid ingredients. The geopolymer precursor dry mixture is characterizable as being ready for mixing with at least water (or, for example, water and the first or more supplemental ingredient) so as to independently prepare the geopolymer composition.

The amounts and proportions of any of the ingredients of the geopolymer precursor and packaged dry mixtures can be readily and independently chosen so as to be useful for preparing the geopolymer composition as described previously. The invention geopolymer precursor dry mixture typically has ingredients of from 1 wt % to 99 wt % water soluble metal silicate powder, 1 wt % to 99 wt % aluminosilicate powder, 0 wt % to 30 wt % particulate solid alkali base, and 0 wt % to 50 wt % of the amorphous silica-containing powder, the total thereof equaling 100 wt % based on total weight of the geopolymer precursor dry mixture. The packaged dry mixture typically has ingredients of from 1 wt % to 99 wt % water soluble metal silicate powder and from 1 wt % to 99 wt % aluminosilicate powder, the total thereof equaling 100 wt % based on total weight of the packaged dry mixture.

Solubility of any solid ingredient of the geopolymer precursor dry mixture (e.g., the water soluble metal silicate powder, aluminosilicate powder, or any supplemental ingredient) in a geopolymer composition useful in the present invention, and thus in water or the aforementioned aqueous metal silicate solution used to prepare the geopolymer composition, can be determined by any suitable means. In some embodiments it is convenient to determine the solubility by analyzing a scanning electron microscope (SEM) image of a cured and dried geopolymer prepared therewith, the analyzing comprising quantifying undissolved residual of the solid component (e.g., undissolved residual of the calcined kaolin powder) in the cured and dried geopolymer. Undissolved residuals, if any, of the solid ingredients of the geopolymer precursor dry mixture comprise particles that preferably are substantially evenly dispersed throughout the cured and dried geopolymer.

The supplemental ingredients can be readily employed so as to modify one or more physical (e.g., particle size, density, wetability (e.g., with water), and curing or drying rate), chemical (e.g., molar ratio of ingredients, pH, and chemical composition), mechanical (e.g., compressive strength and porosity), appearance (e.g., color), and other properties (e.g., transportability) of dry mixtures containing the supplemental ingredients or, ultimately, the geopolymer compositions prepared with, among other ones, the supplemental ingredients. For example, organic polymer latex particles can be added to the geopolymer precursor dry mixture or packaged dry mixture so as to ultimately improve adhesion of a geopolymer composition prepared therewith, or its cured and dried geopolymer residual thereof, to a surface of an organic polymer (e.g., polystyrene) article. If desired, a fumed silica can be added to increase compressive strength and adhesion strength.

In some embodiments the first supplemental ingredient of the geopolymer precursor dry mixture comprises the particulate solid alkali base, the particulate solid alkali base being dry-mixed together with the water soluble metal silicate powder and aluminosilicate powder, thereby the geopolymer precursor dry mixture comprising the particulate solid alkali base, water soluble metal silicate powder, and aluminosilicate powder, the geopolymer precursor dry mixture being characterizable as ready for mixing with water in such a way so as to prepare the geopolymer composition. In some embodiments the first supplemental ingredient of the geopolymer precursor dry mixture comprises the amorphous silica-containing powder, the amorphous silica-containing powder being dry-mixed together with the water soluble metal silicate powder and aluminosilicate powder, thereby the geopolymer precursor dry mixture comprising the amorphous silica-containing powder, water soluble metal silicate powder, and aluminosilicate powder, the geopolymer precursor dry mixture being characterizable as ready for mixing with water in such a way so as to prepare the geopolymer composition. In some embodiments the first supplemental ingredient of the geopolymer precursor dry mixture comprises both the particulate solid alkali base and amorphous silica-containing powder, the particulate solid alkali base and amorphous silica-containing powder being dry-mixed together with the water soluble metal silicate powder and aluminosilicate powder, thereby the geopolymer precursor dry mixture comprising the particulate solid alkali base, amorphous silica-containing powder, water soluble metal silicate powder, and aluminosilicate powder, the geopolymer precursor dry mixture being characterizable as ready for mixing with water in such a way so as to prepare the geopolymer composition. In some embodiments the first supplemental ingredient of the geopolymer precursor dry mixture comprises at least one of the particulate solid alkali base and amorphous silica-containing powder as well as at least one second supplemental ingredient, the second supplemental ingredient being other than the particulate solid alkali base and amorphous silica-containing powder; all of the supplemental ingredients being dry-mixed together with the water soluble metal silicate powder and aluminosilicate powder, thereby the geopolymer precursor dry mixture comprising the at least one of the particulate solid alkali base and amorphous silica-containing powder, as well as the at least one second supplemental ingredient other than the particulate solid alkali base and amorphous silica-containing powder, water soluble metal silicate powder, and aluminosilicate powder, the geopolymer precursor dry mixture being characterizable as ready for mixing with water in such a way so as to prepare the geopolymer composition.

Preferred embodiments of the geopolymer precursor dry mixture and packaged dry mixtures are:

Dry Mixture 1: a packaged pre-mixed dry mixture of a first water soluble metal silicate powder and aluminosilicate powder, the Dry Mixture 1 being contained in one container.

Dry Mixture 2a: a packaged pre-mixed dry mixture of Dry Mixture 1 plus a second water soluble metal silicate powder, the Dry mixture 2a being contained in one container.

Dry Mixture 2b: Dry Mixture 1 and, in a different container, a second water soluble metal silicate powder (a total of two containers).

Dry Mixture 2c: Dry Mixture 2a and, in a different container, an amorphous silica-containing powder (a total of two containers).

Dry Mixture 3a: a packaged pre-mixed dry mixture of Dry Mixture 1 and an amorphous silica-containing powder, the Dry Mixture 3a being contained in one container.

Dry Mixture 3b: Dry Mixture 1 and, in a different container, an amorphous silica-containing powder (a total of two containers).

Dry Mixture 3c: Dry Mixture 3a and, in a different container, a second water soluble metal silicate powder (a total of two containers).

Dry Mixture 4a: a packaged pre-mixed dry mixture of Dry Mixture 1, a second water soluble metal silicate powder, and an amorphous silica-containing powder, the Dry Mixture 4a being contained in one container.

Dry Mixture 4b: Dry Mixture 1 and, in a different container, a second pre-mixed dry mixture of a second water soluble metal silicate powder and an amorphous silica-containing powder (a total of two containers).

Dry Mixture 4c: Dry Mixture 1 and, in different containers, a second water soluble metal silicate powder and an amorphous silica-containing powder (a total of three containers).

Dry Mixtures 1 to 4c independently may further comprise one or more supplemental ingredients that are not the same as any first supplemental ingredient.

Turning to the invention geopolymer precursor package, as mentioned previously, the invention geopolymer precursor package comprises the packaged dry mixture and instructions for mixing the packaged dry mixture with water and optionally the first supplemental ingredient in such a way so as to prepare a geopolymer composition. The packaged dry mixture also comprises solid ingredients. The solid ingredients of the packaged dry mixture comprise the geopolymer precursor dry mixture. As described previously for the geopolymer precursor dry mixture, if desired, any number of different supplemental ingredients can be added to the packaged dry mixture. The packaged dry mixture is characterizable as being ready for mixing with at least water, and optionally a first supplemental ingredient, so as to independently prepare the geopolymer composition. Preferably there is at least one first supplemental ingredient. Preferably at least one first supplemental ingredient is the same as or different than the particulate solid alkali base or amorphous silica-containing powder. Preferably the packaged dry mixture comprises the geopolymer precursor dry mixture.

In some embodiments the packaged dry mixture further comprises one or more first supplemental ingredients, each first supplemental ingredient independently being the same as or different than the first supplemental ingredient described previously for the geopolymer precursor dry mixture. Where the packaged dry mixture further comprises one or more first supplemental ingredients that are the same as the particulate solid alkali base and amorphous silica-containing powder, the packaged dry mixture comprises the geopolymer precursor dry mixture.

The instructions of the geopolymer precursor package can be provided in any form suitable to an intended user of the packaged dry mixture. Examples of such suitable forms are instructions on a label affixed to the package, instructions on an invoice or bill of lading, and instructions on a separate document or posting (e.g., electronic or paper, e.g., instructions paper) that can be provided with or separately from the label, invoice, or bill of lading. In the instructions, the phrase “mixing with water” means intimately contacting with a flowable liquid mostly comprising a substance having a molecular formula H₂O. The flowable liquid can further comprise one or more supplemental ingredients. Preferably the flowable liquid consists essentially of water (e.g., water from a natural source or a water utility) or an aqueous solution of an alkali base.

Preferably the geopolymer precursor package further comprises a container, the packaged dry mixture being contained in the container. The container can be unsealed or, preferably, sealed Examples of suitable containers are mixers, bags, bottles, boxes, buckets, cans, drums, jugs, mixers (e.g., repurposed concrete mixers), and dry bulk material tanks. The instructions for mixing the packaged dry mixture with water preferably are affixed to the container (e.g., as in a form of a label or bill of lading). The bags, buckets, cans, drums, and dry bulk material tanks are preferred and are especially suitable when temporary storage of the packaged dry mixture (e.g., as in a warehouse or retail store outlet) or transportation thereof in a sealable container or personal use amount is desired. In embodiments where the container is a mixer (e.g., a rotatable mixer of a repurposed concrete mixer truck), preferably the instructions are supplied in a form of a separate document (e.g., instructions document) separate from the mixer. Preferably the packaged dry mixture in the container is substantially protected from premature direct contact with a liquid such as, for example, liquid water.

As mentioned previously, the geopolymer composition is prepared from the invention geopolymer precursor dry mixture by the invention of the second or third embodiments or from the invention packaged dry mixture by the process of the fifth embodiment. The invention of the second or third embodiments employs, among other things, water. Preferably the water is obtained from the source of water at a geopolymer composition preparation site. The water can be of any pH. In some embodiments the water employed in the second embodiment is characterizable as having a pH of about 7. In some embodiments the water employed in the second embodiment contains an alkali base dissolved therein and is characterizable as having a pH of greater than 7.

In some embodiments the invention of the second and third embodiments further comprises a preliminary step of dry mixing the water soluble metal silicate powder, aluminosilicate powder, and first supplemental ingredient in such a way so as to prepare the geopolymer precursor dry mixture. In some embodiments the invention of the fifth embodiment further comprises a preliminary step of dry mixing the water soluble metal silicate powder, aluminosilicate powder, and, optionally the first supplemental ingredient, in such a way so as to prepare the packaged dry mixture. The term “dry mixing” means mechanically combining solid ingredients without thermally activating them, i.e., combining the solid ingredients under non-thermally activating conditions. Preferably, the non-thermally activating conditions mean the solid ingredients are combined at a dry mixing temperature of less than 60° C. Preferably the dry mixing temperature is 50° C. or less, more preferably 40° C. or less, and still more preferably 30° C. or less. Examples of mechanically combining are tumbling, shaking, sieving, blowing (e.g., in an ambient temperature air stream), and mechanically vibrating. The term “dry mixture” means a blend that is not thermally activated. That is, the blend consists essentially of solid ingredients (flowable particulates that include the water soluble metal silicate powder, aluminosilicate powder, and, optionally, one or more of the solid supplemental ingredients) and the blend has been prepared by dry mixing such ingredients as defined above. While the blend does not contain a discrete liquid phase, the blend can contain molecules of one or more liquids (phase at 20° C., e.g., water and organic solvents) adsorbed on the surface of the solids (e.g., moisture adsorbed from a humid air environment). Any liquid supplemental ingredient (that would form a discrete liquid phase) is added at the job site shortly before use. While the blend is not thermally activated, the blend can optionally contain one or more solid ingredients that have been thermally activated and cooled (e.g., metakaolin, slag, or fly ash cooled to <60° C.) prior to blending of same with other ingredients in the dry mixing step.

Each of the geopolymer precursor dry mixture and packaged dry mixture independently is characterizable as having a long shelf-life (e.g., 1 week or more, preferably 1 month or more, and more preferably 1 year or more), after which it can be used to prepare the geopolymer composition as described herein. Because of its long shelf-life, the geopolymer precursor dry mixture and packaged dry mixture each independently can be prepared at a manufacturing site, stored for a long period of time at the manufacturing site, a storage site (e.g., at a warehousing site), or the geopolymer composition preparation site, and then used at the geopolymer composition preparation site in such a way so as to prepare the geopolymer composition thereat. The long shelf-life advantageously allows that the geopolymer composition preparation site can be same as, proximal to, or distal from (e.g., 10,000 kilometers) the manufacturing site or storage site, as the aforementioned premature curing of geopolymer compositions plaguing the art heretofore can thereby be avoided.

In some embodiments the invention further comprises a step of transporting the precursor geopolymer dry mixture or geopolymer precursor package from a manufacturing site to the geopolymer composition preparation site in need of a geopolymer composition, the manufacturing and geopolymer composition preparation sites being different. Preferably the method employs a dry bulk material transportation means such as, for example, a dry bulk material truck, dry bulk material railroad car, wheelbarrow, bucket, or belt conveyor, all for the geopolymer precursor dry mixture or packaged dry mixture; or a package delivery means such as, for example, a human being, automobile, package delivery truck, container ship, railroad car, or belt conveyor, all for the geopolymer precursor package. In a less preferred aspect of the third embodiment, the providing step comprises transporting, preferably in separate containers, the water soluble metal silicate powder and aluminosilicate powder to the geopolymer composition preparation site, and dry-mixing the water soluble metal silicate powder, aluminosilicate powder, and first supplemental ingredient together at the geopolymer composition preparation site in such a way so as to prepare the geopolymer precursor dry mixture thereat. As used herein the term “geopolymer composition preparation site” means a geographical area having at least a source of water for preparing the geopolymer composition at the geopolymer composition preparation site. Examples of geopolymer composition preparation sites are geopolymer composition manufacturing sites (e.g., manufacturing plants) and, preferably, sites where the geopolymer composition will also be used. Sites where the geopolymer composition will be used include geopolymer-containing article manufacturing sites (e.g., manufacturing plants) and construction sites (e.g., sites where the geopolymer composition will be applied as a coating (e.g., a geopolymer-coated steel bridge member) or used to construct a geopolymer-containing article such as, for example, a geopolymer composition-containing structure (e.g., a steel reinforced geopolymer pillar, geopolymer composition-containing road, and geopolymer composition-containing building structure). As mentioned previously, the geopolymer compositions of the applied geopolymer compositions and constructed geopolymer composition-containing structure can then be cured and dried so as to respectively give a cured-and-dried geopolymer coating thereof or a cured-and-dried geopolymer-containing structure thereof. Preferably, the articles comprising cured-and-dried geopolymer are prepared and applications of geopolymer compositions are carried out at the geopolymer composition preparation site in need of a geopolymer composition.

In some embodiments the geopolymer composition comprises a basic geopolymer composition, geopolymer-based mortar, or geopolymer-based concrete. The basic geopolymer composition comprises a flowable aqueous slurry prepared by mixing together water and the geopolymer precursor dry mixture, the geopolymer precursor dry mixture consisting essentially of the water soluble metal silicate powder, aluminosilicate powder, and particulate solid alkali base.

The geopolymer-based mortar comprises a bondable composition prepared by mixing together the basic geopolymer composition and at least one filler material. Each filler material preferably consists essentially of one of the aforementioned solid supplemental ingredients. The filler material preferably provides one or more beneficial properties or characteristics to the geopolymer-based mortar such as, for example, inhibiting cracking, improving impact resistance (e.g., by improving elastic modulus thereof), reducing costs (e.g., sand is cheaper than base geopolymer composition), or reducing water absorption (e.g., by reducing volume fraction of porous base geopolymer composition in the geopolymer-based mortar) thereof compared to same properties or characteristics of the basic geopolymer composition. In some embodiments the filler material is an inert filler material, which means a substance that is essentially insoluble in the base geopolymer composition at ambient temperature and pressure. Examples of the inert filler material are sand particles and wollastonite fibers. In some embodiments the filler material is an active filler material, which means a substance of which at least some dissolves in the base geopolymer composition at ambient temperature and pressure. Examples of the active filler material are fly ash, slag, glass powder (e.g., ground soda lime glass such as ground window glass), and rock wool.

The geopolymer-based concrete consists essentially of a matrix composite of the geopolymer-based mortar and aggregates. Preferably the aggregates comprise stone aggregates having an average diameter of greater than 5 millimeters (mm) (e.g., pebbles, broken stone, conglomerate gravel, or ground concrete).

Preferably solid supplemental ingredients and filler materials are mixed with the geopolymer precursor dry mixture at a manufacturing site (e.g., plant for manufacturing the geopolymer precursor dry mixture) or at the geopolymer preparation site (e.g., construction site). Preferably liquid supplemental ingredients and filler materials are mixed with the geopolymer precursor dry mixture, or the base geopolymer composition precursor thereto, at the geopolymer preparation site.

Accordingly the geopolymer composition can be used to prepare a large number of different articles and can have a large number of different applications. Examples of the geopolymer applications are coatings (e.g., on organic polymer, wood, ceramics or metal), thermal (e.g., fire) barriers, sound barriers, foams, and adhesives (e.g., for wood or ceramics). Preferably the coatings enhance aesthetic appearance or, preferably, improve flame-, heat-, light-, mechanical-, or chemical-resistance property, or a combination of two or more properties thereof, of a material coated thereby. Examples of the articles comprising geopolymer are automotive components such as, for example, automotive hoses; building components such as, for example, external and internal building cladding (e.g., an exterior insulation and finishing system); outdoor articles such as, for example, outdoor furniture and signage; lined infrastructure components such as, for example, lined industrial piping (e.g., lined sewer, water, and chemical process piping); and housings such as, for example, electronic device and battery housings.

Articles having a geopolymer coating-ready surface can be coated in part or in whole by the geopolymer composition. Such articles can be in any form or shape. Examples of suitable forms of such articles are solids and foams. Examples of suitable shapes are films, sheets, fibers, particles, and woven or non-woven fabrics (e.g., of thermoplastics). The articles can be prepared by any conventional method such as casting, molding, and extrusion. The articles can be coated with geopolymer composition on interior surfaces, exterior surfaces, or a combination thereof, and then the geopolymer composition coating can be cured and dried. Preferably, the resulting cured and dried geopolymer has not cracked, peeled, or bubbled.

The geopolymer compositions can be contacted to the coating-ready surface, or the portion thereof, of the articles using any contacting methods as would be known in the art. Examples of suitable contacting methods are spreading (e.g., by pumping, mechanically pushing, or flowing), spraying, casting, molding, forming, and stamping. The contacting step provides the geopolymer layer in physical contact with the coating-ready surface, or the portion thereof, of the article. After curing of the geopolymer, preferably the cured geopolymer is characterized as having a drying-ready exposed surface from which at least 30 wt % of the water of the cured geopolymer is removed in the drying step. Preferably, the drying-ready exposed surface of the cured geopolymer is temporarily covered with a water barrier material (e.g., a polymer membrane or glass) during the curing step, and then uncovered before the drying step.

### Comparative Example(s)

### Non-Invention

Comparative Example(s) are provided herein as a contrast to certain embodiments of the present invention and are not meant to be construed as being either prior art or representative of non-invention examples.

### Comparative Example 1

### Conventional Preparation of Geopolymer Composition and Compressive Strength Testing

Calcine 140 grams (g) Pioneer kaolin clay (Imerys Performance Materials, Roswell, Ga., USA) at 700° C. for 2 hours. Prepare an aqueous metal silicate solution by mixing 76.3 g of a sodium silicate solution (Grade 42 from Occidental Chemical Corporation (OxyChem), Los Angeles, Calif., USA), 11.2 g deionized water, and 12.5 g of solid NaOH granules to give the aqueous metal silicate solution. Prepare the geopolymer composition by adding to the aqueous metal silicate solution 65.8 g of the calcined Pioneer kaolin clay, and agitate the resulting mixture using a Lightnin mixer and high shear blade for 3 minutes to give the geopolymer composition. The geopolymer composition is characterized as having a molar ratio of silicon atoms to aluminum atoms of 1.625, a molar ratio of sodium atoms to aluminum atoms of 0.899, and a water content of 36%. Repeat the above procedure three times so as to prepare an additional 3 batches of the geopolymer composition. Pour each of the four geopolymer compositions into separate polystyrene Petri dishes, cover the Petri dishes with lids, wrap the resulting lidded dishes with a flexible electrical tape so as to seal the lids to the dishes, and cure in an oven at 43° C. for overnight. Remove the tape and lids, and dry the uncovered cured geopolymer samples in an oven at 43° C. for overnight. Cut each of the resulting cured and dried geopolymer samples CE 1a to CE 1d into 10 cubes about 7 millimeters (mm) by 7 mm by 11 mm dimensions. Separately determine compressive strength in megapascals (MPa) of each cube using an Instron Model 1122 machine at crosshead speed of 0.1 inch per minute (0.254 centimeter (cm)/minute). Separately for each of the cured and dried geopolymer samples CE 1a to CE 1d, average compressive strength results for its 10 cubes to give an average result for each cured and dried geopolymer sample and determine 95% confidence interval (C.I.). Then average all four average compressive strength results together to give an overall average compressive strength. The averages of compressive strength are reported later in Table 1.

Non-limiting examples of the present invention are described below that illustrate some specific embodiments and aforementioned advantages of the present invention.

### Examples of the Present Invention

### Example 1

### Preparation of a Dry Mixture of a Packaged Dry Mixture Comprising Sodium Silicate Powder and Calcined Pioneer Kaolin Powder

Dry mix together 44.5 g Grade H20 (“H twenty”) amorphous sodium silicate powder (PQ Corporation (sometimes referred to as “Philadelphia Quartz”), Malvern, Pa., USA) and 65.8 g calcined pioneer kaolin, thereby preparing 110 g of the dry mixture of the packaged dry mixture of Example 1.

### Example 2

### Preparation of a Geopolymer Precursor Dry Mixture Comprising Amorphous Sodium Silicate Powder, Calcined Pioneer Kaolin Powder, and Sodium Hydroxide Powder

Dry mix together the 110 g of the dry mixture of the packaged dry mixture of Example 1 and 6.8 g of powdered sodium hydroxide to give 117 g of a dry mixture comprising sodium silicate powder, calcined pioneer kaolin powder, and sodium hydroxide powder that is the geopolymer precursor dry mixture of Example 2.

### Example 3

### Preparation of a Geopolymer Composition Using the Geopolymer Precursor Dry Mixture of Example 2

Add 117 g of the geopolymer precursor dry mixture of Example 2 to 48.6 g water. Agitate the resulting mixture using a Lightnin mixer and high shear blade for 3 minutes to give 165 g of the geopolymer composition of Example 3. The geopolymer composition is characterized as having a molar ratio of silicon atoms to aluminum atoms of 1.625, a molar ratio of sodium atoms to aluminum atoms of 0.899, and a water content of 36%.

### Example 4

### Preparation of a Geopolymer Precursor Dry Mixture Comprising Amorphous Sodium Silicate Powder, Calcined Pioneer Kaolin Powder, and Sodium Hydroxide Granules

Dry mix together 44.5 g Grade H2O amorphous sodium silicate powder (PQ Corporation, Malvern, Pa., USA), 65.8 g calcined pioneer kaolin, and 6.8 g sodium hydroxide granules, thereby preparing 117 g of the dry mixture of the geopolymer precursor dry mixture of Example 4.

### Examples 5a to 5c

### Preparation of a Geopolymer Composition Using the Geopolymer Precursor Dry Mixture of Example 4

Add 117 g of the geopolymer precursor dry mixture of Example 5 to 48.6 g water. Agitate the resulting mixture using a Lightnin mixer and high shear blade for 3 minutes to give 165 g of the geopolymer composition of Example 5a. The geopolymer composition is characterized as having a molar ratio of silicon atoms to aluminum atoms of 1.625, a molar ratio of sodium atoms to aluminum atoms of 0.899, and a water content of 36%.

Repeat the above procedure two times so as to prepare an additional 2 batches of the geopolymer composition, the additional 2 batches being of Examples 5b and 5c.

### Examples 6a to 6c

### Determining Compressive Strength of Cured and Dried Geopolymer Compositions of Examples 5a to 5c

Separately cure and dry each of the geopolymer compositions of Examples 5a to 5c, cube the resulting cured and dried geopolymer samples EX 6a to EX 6c, and determine average compressive strength values and 95% confidence intervals in a manner similar to that described previously in Comparative Example 1. The results are reported below in Table 1.

TABLE 1
average compressive strength values.

| | Average Compressive Strength | |
|---|---|---|
| Sample Number | (MPa) | 95% C.I. |
| CE 1a | 74.9 | 7.6 |
| CE 1b | 66.1 | 6.6 |
| CE 1c | 79.2 | 2.5 |
| CE 1d | 74.9 | 5.6 |
| Average of CE 1a to CE 1d | 73.9 | 3.2 |
| EX 6a | 80.1 | 7.1 |
| EX 6b | 63.2 | 4.7 |
| EX 6c | 76.5 | 4.7 |
| Average of EX 1a to EX 1c | 73.3 | 4.1 |

As shown in Table 1, the cured and dried geopolymer samples EX 6a to EX 6c are characterizable as independently having one or more properties, particularly compressive strength, that are at least comparable to corresponding properties of cured and dried conventionally prepared geopolymer samples CE 1a to CE 1d. Thus, the geopolymer compositions prepared by the process of the second embodiment or method of the third embodiment are useful in preparing articles comprising geopolymer and in geopolymer applications.

### Examples 7a to 7d

### Geopolymer Precursor Packages Comprising a Packaged Dry Mixture

Manufacture at a manufacturing site 11 metric tons of packaged dry mixture comprising 4.5 metric tons sodium silicate powder and 6.5 metric tons calcined pioneer kaolin powder, in batches if necessary, by tumbling the powders in a 20 tons capacity dry bulk mixer. Separately fill to capacity with the packaged dry mixture each of a 10 kilogram (kg) capacity, fiber-reinforced paper bag, a 4 kg capacity polypropylene can, a 200 kg capacity steel drum, and a 10,000 kg capacity dry bulk hopper tank. Affix labels to the bag, can, drum, and tank, the labels having instructions for preparing geopolymer compositions using the packaged dry mixtures contained therein, thereby giving the geopolymer precursor packages of Examples 7a to 7d, respectively. The instructions comprise respectively adding 0.61 kg, 0.24 kg, 12 kg, or 610 kg sodium hydroxide powder to the packaged dry mixtures to give 3-ingredient dry mixtures thereof, and respectively adding the 3-ingredient dry mixtures to 4.7 kg, 1.8 kg, 89 kg, or 4,700 kg water, and tumble or stir the resulting mixtures in a mixer (e.g., a concrete mixer) for 5 minutes.

### Examples 8a to 8d

### Geopolymer Precursor Packages Comprising a Packaged Dry Mixture Comprising a Geopolymer Precursor Dry Mixture

Manufacture at a manufacturing site 11 metric tons of geopolymer precursor dry mixture comprising 4.5 metric tons sodium silicate powder, 6.5 metric tons calcined pioneer kaolin powder, and 0.67 metric ton of sodium hydroxide granules, in batches if necessary, by tumbling the powders in a 20 tons capacity dry bulk mixer. Separately fill to capacity with the geopolymer precursor dry mixture each of a 10 kilogram (kg) capacity, fiber-reinforced paper bag, a 4 kg capacity polypropylene can, a 200 kg capacity steel drum, and a 10,000 kg capacity dry bulk hopper tank. Affix labels to the bag, can, drum, and tank, the labels having instructions for preparing geopolymer compositions using the geopolymer precursor dry mixtures contained therein, thereby giving the geopolymer precursor packages of Examples 8a to 8d, respectively. The instructions comprise respectively adding the geopolymer precursor dry mixtures to 4.2 kg, 1.7 kg, 84 kg, or 4,200 kg water, and tumble or stir the resulting mixtures in a mixer for 5 minutes.

### Example 9

### Transporting Packaged Dry Mixtures or Geopolymer Precursor Dry Mixtures from a Manufacturing Site to a Construction Site

Separately transport each of the packaged dry mixtures or geopolymer precursor dry mixtures of Examples 1, 2, and 4 and the geopolymer precursor packages of Examples 7a to 7d and 8a to 8d from the manufacturing site to a geopolymer composition preparation site, the manufacturing and geopolymer composition preparation sites being different and the transportation respectively being via any one of the following dry bulk material transportation means: a dry bulk material truck, dry bulk material railroad car, wheelbarrow, bucket, or belt conveyor, all for the geopolymer precursor dry mixtures of Examples 1, 2, and 4; and a human being, automobile, package delivery truck, container ship, railroad car, or belt conveyor, all for the geopolymer precursor packages of Examples 7a to 7d and 8a to 8d.

As shown by the Examples, the invention advantageously provides, among other things, a means for directly (i.e., without employing an intermediate solution such as a metal silicate solution) and rapidly (e.g., less than 1 hour) preparing a geopolymer composition by contacting solid ingredients (the geopolymer precursor dry mixture or packaged dry mixture) and water together. The invention also provides a stable, storable, and transportable source of ingredients other than water for geopolymer compositions, the stable, storable, and transportable source comprising the geopolymer precursor dry mixture or packaged dry mixture. The stability, storability, and transportability characteristics of the geopolymer precursor dry mixture and packaged dry mixture lend the geopolymer precursor and packaged dry mixtures to being a flexible means of freshly preparing geopolymer compositions of same or varying proportions of ingredients and of doing such preparations at any geopolymer composition preparation site, no matter how remote the geopolymer composition preparation site is from sites where the geopolymer precursor and packaged dry mixtures are manufactured. Another benefit is that the invention desirably avoids transportation of water-based geopolymer ingredients to the geopolymer composition preparation site. Once at the geopolymer composition preparation sites, the geopolymer precursor dry mixture or packaged dry mixture can be contacted with water and any optional supplemental ingredients sourced therefrom (e.g., water from a water utility or a natural body of water such as a river or lake) in varying proportions as desired so as to make geopolymer compositions of same or varying proportions of ingredients thereof.

While the present invention has been described above according to its preferred embodiments, it can be modified within the spirit and scope of this disclosure. This application is therefore intended to cover any variations, uses, or adaptations of the present invention using the general principles disclosed herein. Further, the application is intended to cover such departures from the present disclosure as come within the known or customary practice in the art to which this present invention pertains and which fall within the limits of the following claims.

1. A geopolymer precursor dry-mixture comprising a water soluble metal silicate powder and an aluminosilicate powder.

2. The geopolymer precursor dry-mixture as in claim 1, the geopolymer precursor dry-mixture further comprising a first supplemental ingredient, the first supplemental ingredient comprising a particulate solid alkali base or an amorphous silica-containing powder

3. The geopolymer precursor dry-mixture as in claim 2, the geopolymer precursor dry-mixture further comprising a second supplemental ingredient.

4. A process for preparing a geopolymer composition, the process comprising mixing water and a geopolymer precursor dry-mixture together in such a way so as to prepare a geopolymer composition, the geopolymer precursor dry-mixture comprising a water soluble metal silicate powder, an aluminosilicate powder, and a first supplemental ingredient, the first supplemental ingredient comprising a particulate solid alkali base or an amorphous silica-containing powder.

5. The process as in claim 4, the process further comprising a preliminary step of dry-mixing the water soluble metal silicate powder, aluminosilicate powder, and first supplemental ingredient together under non-thermally activating conditions in such a way so as to prepare the geopolymer precursor dry-mixture.

6. A method of preparing a geopolymer composition at a geopolymer composition preparation site in need thereof, the method comprising:
Providing a geopolymer precursor dry-mixture to a geopolymer composition preparation site in need of a geopolymer composition, the geopolymer precursor dry-mixture comprising a water soluble metal silicate powder, an aluminosilicate powder, and a first supplemental ingredient, the first supplemental ingredient comprising a particulate solid alkali base or an amorphous silica-containing powder and the geopolymer composition preparation site comprising a source of water; and
Mixing water from the source of water and the geopolymer precursor dry-mixture together in such a way so as to prepare the geopolymer composition at the geopolymer composition preparation site.

7. The method as in claim 6, the method further comprising a preliminary step of dry-mixing the water soluble metal silicate powder, aluminosilicate powder, and first supplemental ingredient together under non-thermally activating conditions in such a way so as to make the geopolymer precursor dry-mixture.

8. The method as in claim 6, the providing step further comprising preparing the geopolymer precursor dry-mixture at a manufacturing site and transporting the geopolymer precursor dry-mixture from the manufacturing site to the geopolymer composition preparation site, the manufacturing and geopolymer composition preparation sites being different.

9. The invention as in claim 1, the first supplemental ingredient comprising the particulate solid alkali base.

10. The invention as in claim 1, the first supplemental ingredient comprising the amorphous silica-containing powder.

11. The invention as in claim 1, the first supplemental ingredient comprising a dry-mixture of the particulate solid alkali base and the amorphous silica-containing powder.

12. A geopolymer precursor package comprising a packaged dry-mixture comprising a water soluble metal silicate powder and an aluminosilicate powder and instructions for mixing the packaged dry-mixture with water, and optionally with a first supplemental ingredient, in such a way so as to prepare a geopolymer composition, the first supplemental ingredient comprising a particulate solid alkali base or an amorphous silica-containing powder.

13. The geopolymer precursor package as in claim 12, the geopolymer precursor package further comprising a container, the packaged dry-mixture being disposed in the container.

14. A process for preparing a geopolymer composition, the process comprising mixing a packaged dry-mixture, water, and optionally a first supplemental ingredient, together in such a way so as to prepare a geopolymer composition, the packaged dry-mixture comprising a water soluble metal silicate powder and an aluminosilicate powder; and the first supplemental ingredient comprising a particulate solid alkali base or an amorphous silica-containing powder.
